(19) United States
(12) Patent Application Publication
(10) Pub. No.: US 2020/0133952 A1
(43) Pub. Date: Apr. 30, 2020

(54) NATURAL LANGUAGE GENERATION SYSTEM USING GRAPH-TO-SEQUENCE MODEL

(71) Applicant: International Business Machines Corporation, Armonk, NY (US)

(72) Inventors: Vadim SHEININ, Yorktown Heights, NY (US); Zhiguo WANG, Yorktown Heights, NY (US); Lingfei wu, Elmsford, NY (US); Kun xu, Yorktown Heights, NY (US)

(21) Appl. No.: 16/176,625

(22) Filed: Oct. 31, 2018

(51) Int. Cl. G06F 16/2452; G06F 16/242; G06F 17/28; G06N 3/04

(52) U.S. Cl. CPC G06F 16/24522; G06N 3/04; G06F 17/289; G06F 16/2448

(57) ABSTRACT

A method of machine translation includes receiving a query as input data. The input data is converted, using a processor on a computer, into a graph.

### BACKGROUND

The present invention relates generally to machine translation into text. More specifically, a Structured Query Language (SQL) query is mapped into a directed graph format as an input for further conversion into natural language, using a graph-to-sequence model.

Existing methods for machine translation into natural language use either a template-based method or a deep learning-based method. For example, in the exemplary SQL query shown in FIG. 1, the goal of the SQL-to-text task is to automatically generate human-like descriptions that interpret the meaning of a given structured query language (SQL) query. This task is critical, for example, to the natural language interface to a database, since it helps non-expert database users to understand the esoteric SQL queries that are used to retrieve answers through the question-answering process using various text embeddings techniques.

In the template-based method, either templates or handcrafted grammars are used to convert an utterance to its content. Key disadvantages of the template-based method include the characteristics that it is time consuming to manually create the templates, and the templates are limited to specific domains.

Despite requiring intensive human efforts to design templates or rules, these approaches still tend to generate rigid and stylized language that lacks the natural text of the human language. To address this concern, another method uses a sequence-to-sequence (Seq2Seq) network to model the SQL query and natural language jointly. However, since the SQL is designed to express graph-structured query intent, the sequence encoder may need an elaborate design to fully capture the global structure information.

Intuitively, various graph encoding techniques based on deep neural networks or based on Graph Kernels, whose goal is to learn the node-level or graph-level representations for a given graph, would seem to be more appropriate to tackle this problem. The present invention provides a new mechanism demonstrating this latter approach.

### SUMMARY

According to an exemplary embodiment, the present invention describes a method of machine translation, including receiving a query as input data; and converting, using a processor on a computer, the input data into a graph.

Also described herein is a method of machine translation for input queries for a database, including receiving input data as data representing a graph; for each node of the graph, encoding nodes of the graph by accumulating information from neighboring nodes of a predetermined distance; and providing an output of the encoding into a decoder that outputs components for words of a natural language.

Also described herein is an SQL-to-text translator, including a processor and a non-transitive memory device associated with the processor, the memory device storing a set of instructions permitting the processor to execute a method to translate a Structured Query Language (SQL) query into natural language text, wherein the method comprises: receiving an SQL query as input data; converting, using the processor, the input SQL query data into data representing a graph; and converting the graph into words of the natural language.

### BRIEF DESCRIPTION OF THE DRAWINGS

FIG. 1 shows an exemplary SQL query 100 used to explain the method of the present invention;

FIG. 2 shows in flowchart format 200 the basic sequence of the present invention;

FIG. 3 shows an exemplary framework 300 of a Graph2Seq model used in the present invention;

FIG. 4 shows a directed graph representation 400 of the SQL query shown in FIG. 1;

FIG. 5 depicts a cloud computing environment according to an embodiment of the present invention; and

FIG. 6 depicts abstraction model layers according to an embodiment of the present invention.

### DETAILED DESCRIPTION

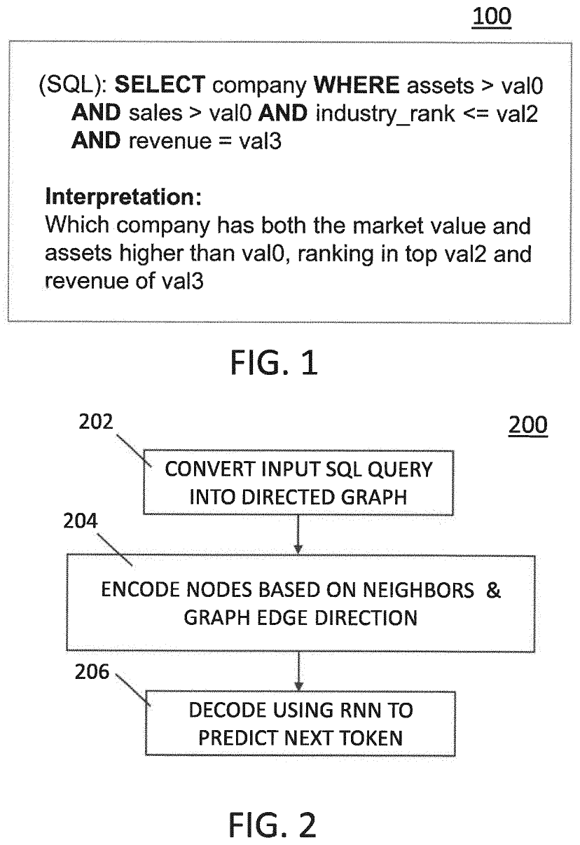

In summary of the present invention, FIG. 2 shows a high-level flowchart 200 of the method used for the present invention. The present invention, in step 202, introduces a new strategy to represent an input SQL query such as exemplarily shown in FIG. 1 as represented in graph data and then, in step 204, further makes full use of a novel graph-to-sequence (Graph2Seq) model that encodes this graph structure, and finally, in step 206, uses a decoder to decode its encoded interpretation into human-readable sentences of a natural language. On the encoder side in step 204, in a preferred embodiment, the present invention extends the graph encoding work by encoding the edge direction information into the node embedding, so that the graph is a directed graph. However, the present invention also works on simple graph data.

The encoder of the present invention learns the representation of each node by aggregating information from its K-hop neighbors. Different from previous methods which neglects the edge direction, the present invention classifies the neighboring nodes of a node into two classes of nodes, according to the edge direction v, i.e., forward nodes (v directs to) and backward nodes (direct to v). Further, two distinct aggregators are applied to aggregate the information of these two types of nodes, resulting in two representations. The node embedding of v is the concatenation of these two representations. Given the learned node embeddings, the present invention further introduces a pooling-based and an aggregation-based method to generate the graph embedding.

On the decoder side, in step 206, the present invention discloses a recurrent neural network (RNN)-based decoder which takes the graph vector representation as the initial hidden state to generate the sequences while employing an attention mechanism over all node embeddings. Experimental results show that the present invention achieves state-of-the-art performance on the WikiSQL dataset and Stack-overflow dataset.

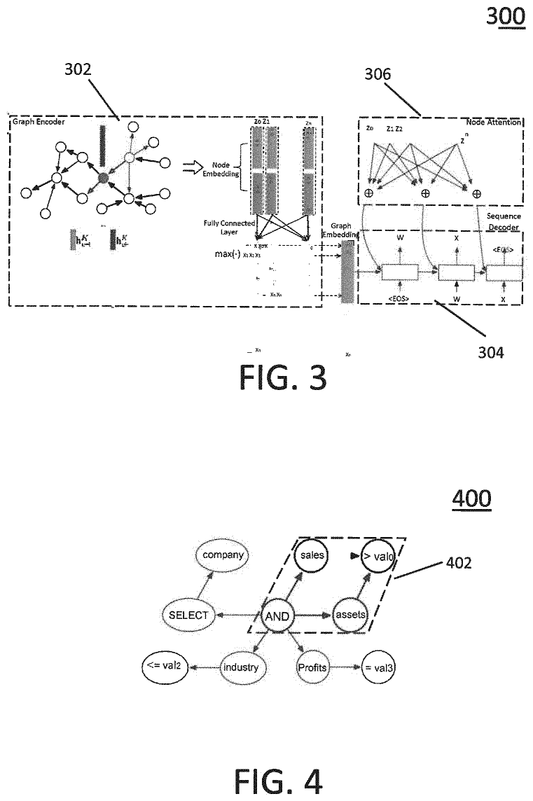

Accordingly, FIG. 3 shows the framework of the Graph2Seq model of the present invention, as including a graph encoder 302, a sequence decoder 304, and a node attention mechanism 306. Following the conventional encoder-decoder architecture, the graph encoder 302 first generates node embeddings, and then constructs graph embeddings based on the learned node embeddings. Finally, the sequence decoder 304 takes both the graph embeddings and node embeddings as input and employs attention 306 over the node embeddings whilst generating sequences. Additional details of this model are discussed below.

### Graph Representation of the Input SQL Query

First, however, before further describing the Graph2Seq model, another key aspect of the present invention is its recognition that representing the input SQL query as a graph instead of a sequence would better preserve the inherent structure information in the query. An example is illustrated in the dashed frame 402 in FIG. 4 that shows the graph representation 400 of the SQL query 100 exemplarily shown in FIG. 1, as a directed graph, although the method described herein also works on simple graphs. One can see that representing components of the query as a graph instead of a sequence could help a model to better learn the correlation between this graph pattern and the interpretation of, for example, “. . . both X and Y higher than Z . . . ” of the query shown in FIG. 1. This observation becomes a motivation of a novel technique of the present invention, that of representing an SQL query as a graph and, in a preferred embodiment, as a directed graph. The following example demonstrates an exemplary method to transform an SQL query to a directed graph. It should be clear that the following example can be simply extended to cope with more general SQL queries having complex syntaxes such as JOIN or ORDER BY.

The directed graph 400 of FIG. 4 is can be derived, as follows.

### The SELECT Clause

For the SELECT clause exemplarily shown in the directed graph 400 of FIG. 4, such as “SELECT company”, a node is created as assigned with text attribute select. This SELECT node connects with column nodes whose text attributes are the selected column names such as company. For SQL queries that contain aggregation functions, such as COUNT or MAX, an aggregation node is added, which is connected with column nodes, and similar to the SELECT example, their text attributes would be the aggregation function names.

### The WHERE Clause

A WHERE clause usually contains more than one condition. For each condition, the same process is used to create nodes as for the SELECT clause. For example, in FIG. 4, for the first condition nodes assets and >val₀ are created, for the second condition nodes sales and >valₒ are created. Constraint nodes that have the same text attribute (e.g., >val₀ in FIG. 3) are then integrated. For a logical operator such as AND, OR, and NOT, a node is created that connects with all column nodes that the operator works on. Finally, these logical operator nodes are connected with the SELECT node.

### Graph-to-Sequence Model

Relative to steps 204 and 206 in FIG. 2, based on the constructed graph for an input SQL query, the present invention makes full use of a novel graph-to-sequence model also developed by the present inventors, which consists of a graph encoder 302 to learn the embedding for the graph-structured SQL query, and a sequence decoder 304, with an attention mechanism 306, to generate words of a natural language. Conceptually, the graph encoder 302 that implements step 204 generates the node embedding for each node by accumulating information from that node's K-hop neighbors, and produces a graph embedding for the entire graph by abstracting all node embeddings. This decoder 304 that implements step 206 in FIG. 2 takes the graph embedding as its initial hidden state and calculates the attention over all node embeddings on the encoder side to generate natural language interpretations. The Graph2Seq model 300 shown in FIG. 3 will now be described, as follows.

### Node Embedding

Given the graph [symbol] =[ [symbol] [symbol] ], since the text attribute of a node may include a list of words, a Long Short Term Memory (LSTM) is first used to generate the feature vector aᵥ for all nodes v, from each v's text attribute. These feature vectors are used as initial node embeddings. Then, the model incorporates information from a node's neighbors within K hops into its representation on the graph by repeating the following process K times:

$$\begin{matrix} h \text{?} = {a}_{v} , h \text{?} = {a}_{v} , ∀ v ∈ V & ( 1 ) \\ {h}^{k} \text{?} = {M}^{k} \text{?} ( \{ {h}^{k - 1} \text{?} , ∀ u ∈ N \text{?} ( v ) \} ) & ( 2 ) \\ {h}^{k} \text{?} = σ ( {W}^{k} \cdot CONCAT ( {h}^{k - 1} \text{?} , {h}^{k} \text{?} ) ) & ( 3 ) \\ {h}^{k} \text{?} = {M}^{k} \text{?} ( \{ {h}^{k - 1} \text{?} , ∀ u ∈ N \text{?} ( v ) \} ) & ( 4 ) \\ {h}^{k} \text{?} = σ ( {W}^{k} \cdot CONCAT ( {h}^{k - 1} \text{?} , {h}^{k} \text{?} ) ) \\ \text{?} \text{indicates text missing or illegible when filed} & ( 5 )\end{matrix}$$

where kϵ{1, . . . , K} is an iteration index, N is the neighborhood function, h_{v├}^{k}(h_{v┤}^{k}) is node v's forward (backward) representation which aggregates the information of nodes in N_{├}(v)(N_{┤}(v)(N_{┤}(v)), M^{k} and M^{k} are the forward and backward aggregator functions, W^{k} denotes weight matrices, σ is a non-linearity function. The neighborhood function N returns nodes as follows: N_{├}(v) returns the nodes that v directs to, and N_{┤}(v) returns the nodes that direct to v.

In more detail, for each node vϵV, the forward representations of its immediate neighbors {h_{u├}^{k-1}, ∀u∈N_{├}(v)} are aggregated into a single vector h_{├(v)}^{k}, (equation 2 above). Note that this aggregation step only uses the representations generated at previous iteration and its initial representation is aᵥ. Then v's current forward representation h [symbol] _{├}^{k-1} is concatenated with the newly generated neighborhood vector h_{N├(v)}^{k} . This concatenated vector is fed into a fully connected layer with nonlinear activation function σ, which updates the forward representation of v to be used at the next iteration (equation 3). Next, the backward representation of v is updated in similar fashion (equation 4 & 5).

Finally, the concatenation of the forward and backward representation at last iteration K, is used as the resulting representation of v. Since the neighbor information from different hops may have a different impact on the node embedding, a distinct aggregator function is learned at each step. This aggregator feeds each neighbor's vector to a fully-connected neural network and an element-wise max-pooling operation is applied to capture different aspects of the neighbor set.

### Graph Embedding

Most existing works of graph convolution neural networks focus more on node embeddings rather than graph embeddings (GE) since their focus is on the node-wise classification task. However, graph embeddings that convey the entire graph information are essential to the downstream decoder, which is crucial to the task described herein. For this purpose, the present invention uses either of two ways to generate graph embeddings, namely, the Pooling-based and Node-based methods.

### Pooling-Based GE

This method feeds the obtained node embeddings into a fully-connected neural network and applies the element-wise max-pooling operation on all node embeddings. In experiments, significant performance improvement was not observed using min-pooling and average-pooling.

### Node-Based GE

This method adds a super node vs that is connected to all other nodes by a special type of edge. The embedding of vs, which is treated as graph embedding, is produced using node embedding generation algorithm mentioned above.

### Sequence Decoding

The decoder is an RNN which predicts the next token yᵢ in an output stream of words of a natural language, given all the previous words y_{<i}=y₁, . . . , yᵢ₋₁, the RNN hidden state sᵢ for time-step i, and the context vector cᵢ that captures the attention of the encoder side. In particular, the context vector cᵢ depends on asset of node representations (h₁, . . . , h_{γ}) to which the encoder maps the input graph. The context vector cᵢ is dynamically computed using an attention mechanism over the node representations. In particular, the context vector cᵢ depends on a set of node representations (z₁, . . . z_{γ}) which the graph encoder maps the input graph to. Each node representation zᵢ contains information about the whole graph with a strong focus on the parts surrounding the i-th node of the input graph. The context vector cᵢ is computed as a weighted sum of these node presentations and the weight aᵢⱼ of each node representation is computed by:

$${c}_{i} = {\sum }_{j = i}^{γ} {α}_{ij} {h}_{j} , \\ where {α}_{ij} = \frac{exp ( {e}_{ij} )}{{\sum }_{k = 1}^{γ} exp ( {e}_{ik} )} , \\ {e}_{ij} = a ( {s}_{i - 1} , {h}_{j} )$$

where a is an alignment model which scores how well the input node around position j and the output at i match. The score is based on the RNN hidden state sᵢ₋₁ and the j-th node representation of the input graph. The alignment model a is parameterized as a feed-forward neural network which is jointly trained with other components.

The model is jointly trained to maximize the conditional log-probability of the correct description given a source graph with respect to the parameters θ of the model:

θ*=argmax_{θ}Σₙ₌₁^{N}Σₜ₌₁^{T}^{ₙ}log p(yₜⁿ|u_{<t}ⁿ,xⁿ)

where (xⁿ,yⁿ) is the n-th SQL-interpretation pair in the training set, and Tₙ is the length of the n-th target sentence yⁿ. In the inference phase, in an exemplary embodiment, the beam search algorithm with beam size=5 is used.

Experiments were run to compare the method of the present invention with other methods to convert SQL-to-text, such as models using Seq2Seq and Tree2Seq conversions of SQL-to-text. The method of the present invention was shown to significantly outperform these earlier models, using the WikiSQL and Stackoverflow datasets and was demonstrated to achieve state-of-the-art performance. It is noted that the WikiSQL dataset consists of a corpus of 87,726 hand-annotated SQL query and natural language question pairs. These SQL queries are further split into training (61,297 examples), development (9,145 examples), and test sets (14,284 examples). The StackOverflow dataset consists of 32,337 SQL query and natural language question pairs.

To one of ordinary skill in the art, these experimental results would confirm the premise underlying the present invention: the conventional Seq2Seq model does not fully capture the global structure of an input SQL query whereas a graph-to-sequence model using a directed graph input provides more information concerning the structure of the SQL query.

It would also to be understood by one of ordinary skill that, although this disclosure includes a detailed description of implementation on cloud computing, as follows, the implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

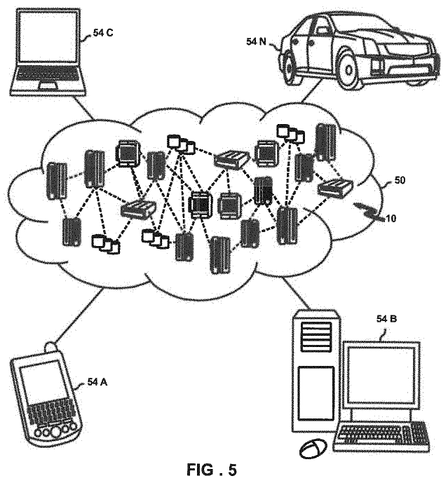

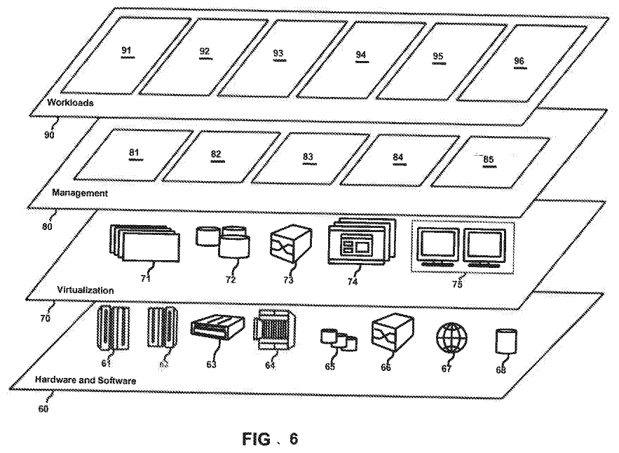

Referring now to FIG. 5, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 5 are intended to be illustrative only and that computing nodes 10 and cloud computing environment 50 can communicate with any type of computerized device over any type of network and/or network addressable connection (e.g., using a web browser).

Referring now to FIG. 6, a set of functional abstraction layers provided by cloud computing environment 50 (FIG. 5) is shown. It should be understood in advance that the components, layers, and functions shown in FIG. 6 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture-based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality 91-96 for which the cloud computing environment may be utilized. Examples of workloads and functions which may be provided from this layer include tasks related to the implementation of the present invention such as, for example, receiving an input SQL query from a non-expert user, providing a conversion into natural language of the input SQL query and returning it to the non-expert user, receiving a confirmation from the user that the translated SQL query is acceptable, and then executing the input SQL query on a database designated by the non-expert user.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

While the invention has been described in terms of several exemplary embodiments, those skilled in the art will recognize that the invention can be practiced with modification.

Further, it is noted that, Applicants' intent is to encompass equivalents of all claim elements, even if amended later during prosecution.

What is claimed is:

1. A method of machine translation for input queries for a database, said method comprising:
receiving a Structured Query Language (SQL) query as input data;
converting, using a processor on a computer, the input SQL query data into data representing a graph; and
converting the graph into words of a natural language.

2. The method of claim 1, wherein the graph comprises a directed graph.

3. The method of claim 1, further comprising,
for each node of the graph, encoding nodes of the graph by accumulating information from neighboring nodes of a predetermined distance; and
providing an output of the encoding into a decoder that outputs components for words of a natural language.

4. The method of claim 3, wherein the decoder comprises a recurrent neural network (RNN)-based decoder.

5. The method of claim 4, wherein the RNN-based decoder comprises an attention-based RNN.

6. The method of claim 5, wherein a context vector cᵢ provides an aspect of attention to the RNN-based decoder by containing information about the whole graph with a strong focus on the parts surrounding the i-th node of the input graph.

7. The method of claim 6, wherein the context vector cᵢ is computed as a weighted sum of node presentations.

8. The method of claim 1, as embodied in a set of machine-readable instructions stored on a non-transitive storage device.

9. The method of claim 1, as implemented as a cloud service.

10. A method of machine translation for input queries for a database, said method comprising:
receiving input data as data representing a graph;
for each node of the graph, encoding nodes of the graph by accumulating information from neighboring nodes within a predetermined distance from that node; and
providing an output of the encoding into a decoder that outputs components for words of a natural language.

11. The method of claim 10, wherein the data representing a graph comprises data of a directed graph.

12. The method of claim 10, wherein the decoder comprises a recurrent neural network (RNN)-based decoder.

13. The method of claim 12, wherein the RNN-based decoder comprises an attention-based RNN.

14. The method of claim 13, wherein a context vector cᵢ provides an aspect of attention to the RNN-based decoder by containing information about the whole graph with a strong focus on the parts surrounding the i-th node of the input graph.

15. The method of claim 14, wherein the context vector cᵢ is computed as a weighted sum of node presentations.

16. The method of claim 10, as embodied in a set of machine-readable instructions stored on a non-transitive storage device.

17. The method of claim 10, as implemented as a cloud service.

18. An SQL-to-text translator, comprising:
a processor; and
a non-transitive memory device associated with the processor, the memory device storing a set of instructions permitting the processor to execute a method to translate a Structured Query Language (SQL) query into natural language text,
wherein the method comprises:
receiving an SQL query as input data;
converting, using the processor, the input SQL query data into data representing a graph; and
converting the graph into words of the natural language.

19. The SQL-to-text translator of claim 18, wherein the graph comprises a directed graph.

20. The SQL-to-text translator of claim 18, wherein the method converting the graph into natural language words comprises:
for each node of the graph, encoding nodes of the graph by accumulating information from neighboring nodes of a predetermined distance; and
providing an output of the encoding into an attention-based RNN decoder that outputs components for words of a natural language.
